(19) United States
(12) Patent Application Publication
(10) Pub. No.: US 2011/0296656 A1
(43) Pub. Date: Dec. 8, 2011

(54) CASKET

(76) Inventors: Gregory J. Filipek, Northville, MI (US); Daniel B. Sauger, Macomb, MI (US); Edward J. Engler, Sterling Heights, MI (US); Timothy M. Hamlock, Macomb, MI (US); Jeff Park, Milford, MI (US); Gary Vincent Borg, Berkley, MI (US); Franco Pahmer, Chattanooga, TN (US)

(21) Appl. No.: 13/080,306

(22) Filed: Apr. 5, 2011

Related U.S. Application Data
(60) Provisional application No. 61/321,099, filed on Apr. 5, 2010.

(51) Int. Cl. A61G 17/007; B21D 51/26; A61G 17/00

(52) U.S. Cl. 27/19; 27/2; 413/1

(57) ABSTRACT

The present invention discloses a casket having a shell and a cover, the shell having a bottom panel and a side wall. The side wall can have a plurality of bent corners with at least a portion of each bent corner being seamless. A lower portion of the side wall can have a J-shaped section with at least a portion of the bottom panel located within the J-shaped section of the side wall. In addition, the bottom panel can have an inverted U-shaped section adjacent the side wall with at least a portion of the U-shaped section located within the J-shaped section of the side wall.

### CROSS-REFERENCE TO RELATED APPLICATION

This application claims priority of U.S. Provisional Patent Application Ser. No. 61/321,099 filed Apr. 5, 2010, which is incorporated in its entirety herein by reference,

### FIELD OF THE INVENTION

The present invention relates in general to a casket and in particular to an improved casket having features that afford for reduced manufacturing costs.

### BACKGROUND OF THE INVENTION

Caskets typically include a base or shell with a lid or cover that is hinged to the base. The lid or cover can be a single cover that extends the entire length of the casket or have separate lower and upper cover portions that are capable of being individually opened and closed. The shell and/or the cover can be made from sheet metal with the shell typically having a bottom panel attached to a side wall in order to make a generally rectangular shaped bottom portion of the casket.

Heretofore caskets have been typically made using traditional fabrication techniques. For example, four separate sheet metal panels are welded together in order to form a plurality of side walls and a separate sheet metal bottom panel is welded to the side walls in order to form the base or shell. After welding of the side wall panels and the bottom panel, sanding and/or grinding of the welded sections is required in order to provide a smooth and aesthetically pleasing surface on the casket. As such, extensive labor for the fabrication of caskets is required. Therefore, a casket, and a process for making a casket, that requires significantly less cleanup and labor for manufacturing would be desirable.

### SUMMARY OF THE INVENTION

The present invention discloses a casket having a shell and a cover, the shell having a bottom panel and a side wall. In some instances, the side wall has a plurality of bent corners with at least a portion of each bent corner being seamless. For example, one or more of the seamless bent corners can have a cutout section with a seam therebetween and, as such, only a portion of the bent corner is seamless. In the alternative, one or more of the plurality of bent corners can be completely seamless, for example a corner made by roller bending or stretch roller bending a piece of sheet metal. In such instances, the side wall can be made from a single piece of sheet metal with only one joining seam, the joining seam being a welded seam welded from inside the side wall. In other instances, the side wall is made from two pieces of sheet metal and has only two joining seams that are welded from inside the side wall.

A lower portion of the side wall can have a J-shaped section with at least a portion of the bottom panel located within the J-shaped section of the side wall. In addition, the bottom panel can have an inverted U-shaped section adjacent the side wall with at least a portion of the U-shaped section located within the J-shaped section of the side wall.

The casket shell can also be made from a single piece of sheet metal such that the bottom panel and a plurality of side walls are integral with each other. In such instances, the plurality of side walls are bent at generally 90 degree angles to the bottom panel and form a plurality of corners between the plurality of side walls. In addition, the plurality of corners can be welded from, and have a weld bead located, inside the shell.

A process for making a casket is also included, the process including forming a bottom panel from a first piece of sheet metal, forming a cover from a second piece of sheet metal, and stretch roller bending a third piece of sheet metal to form a panel with a plurality of seamless corners. Thereafter, at least two opposed edges of the panel can be joined to form a generally rectangular casket side wall. The bottom panel and cover are then attached to the casket side wall. The joining of the at least two opposed edges of the panel can be performed by welding the edges from inside the casket side wall and thus result in no weld bead being present on the outer surface of the side wall and thus no grinding and/or clean up is required in order to produce a smooth surface for viewing, painting and the like. The process can further include hemming a bottom edge of the casket side wall to form a tab extending in an inwardly direction and the bottom panel can extend over the tab when it is attached to the casket side wall.

In some instances, the process includes removing a plurality of sections from the third piece of sheet metal in order to form a panel with a plurality of cut-out sections. Thereafter, the panel is bent to form a plurality of bent corners with each corner having one of said cut-out sections and a seam. At least two opposed edges of the panel are joined to form a generally rectangle casket side wall and the bottom panel and the cover are attached to the side wall. In addition, each seam at each of the bent corners can be welded from inside the casket and a sealant can be applied between the bottom panel and the casket side wall.

### BRIEF DESCRIPTION OF THE DRAWINGS

FIG. 1 is a perspective view of a casket according to an embodiment of the present invention;

FIG. 2 is a perspective view of a casket according to another embodiment of the present invention;

FIG. 3 is a top perspective view of the casket in FIG. 1 without a cover;

FIG. 4 is a perspective view of a piece of sheet metal used to make a sidewall for the casket in FIG. 1 illustrating a cut-out section before bending of the sheet metal;

FIG. 5 is a top view of the casket in FIG. 1 without a cover;

FIG. 6 is a perspective view a piece of sheet metal used to make a sidewall for the casket in FIG. 1 illustrating a plurality of cut-out sections before bending of the sheet metal;

FIG. 7 is a perspective view of a prior art welding process for welding corners of a casket;

FIG. 8 is a perspective view of an inventive welding process for welding corners of a casket;

FIG. 9 is a perspective view of a piece of sheet metal used to make the sidewall for the casket in FIG. 2 before bending of the sheet metal;

FIG. 10 is a perspective view of the piece of sheet metal in FIG. 9 after roller bending or stretch roller bending has been used to make the sidewall for the casket in FIG. 2;

FIG. 11 is a perspective view of the sidewall for the casket in FIG. 2 illustrating one joining seam;

FIG. 12 is a bottom perspective view of the casket in FIG. 1;

FIG. 13 is an end cross-sectional view of section 13-13 in FIG. 12;

FIG. 14 is an end cross-sectional view of a sidewall attached to a bottom panel for a casket according to an embodiment of the present invention;

FIG. 15 is a top perspective view of a bottom panel and a plurality of sidewalls made from a single piece of sheet metal before bending of the sidewalls;

FIG. 16 is a top perspective view of the single piece of sheet metal shown in FIG. 15 during bending of the sidewalls;

FIG. 17 is a top perspective view of the single piece of sheet metal shown in FIGS. 15 and 16 after bending of the sidewalls to make a shell for a casket according to an embodiment of the present invention; and

FIG. 18 is an end view of a bottom panel overlapping a tab of a sidewall with a sealant therebetween.

### DETAILED DESCRIPTION OF THE INVENTION

The present invention discloses, and has utility as, an improved casket and an improved process for making a casket. The casket can include an upper portion known as a base or shell and a lower portion known as a cover. In addition, the shell can include or be made from a bottom panel with one or more side walls. In some instances, the one or more side walls have a plurality of corners. In addition, the plurality of corners can be a plurality of sharp bent corners, or in the alternative, a plurality of round bent corners. For the purposes of the present invention, the term sharp bent corners is defined as corners having a radius of curvature of less than 0.5 inches, sometimes referred to as a mitered corner, and the term round bent corners is defined as corners having a radius of curvature of greater than 0.5 inches, sometimes referred to as a non-mitered corner.

If the corners are sharp bent corners, then a cut-out section can be present within the side wall at the corner region, the cut-out section resulting in a seam being present between two adjacent side walls. In some instances, the cut-out section can be taken or removed from the side wall using electric discharge machining (EDM). It is appreciated that in contrast to laser cutting, plasma cutting, etc., of the side wall in which an edge having slag attached thereto is produced, EDM machining of the cut-out sections can afford a corner having two opposed side wall sections with generally smooth edges that fit against each other and thereby provide a seam with a minimum and/or essentially no gap between the sections. It is further appreciated that other methods can be used to provide the cut-out sections such as water-jet cutting, abrasive water-jet cutting and the like. In addition, such a seam at a sharp bent corner can be welded from inside the corner/shell such that a smooth surface on the outside of the corner/shell is provided and sanding, grinding, etc. of the outside corner surface is not required. In the alternative, if the corners are round bent corners, the corners can be seamless.

In some instances, the plurality of side walls can be made from a single piece of sheet metal with only one side wall weld seam used to join opposite ends of the sheet metal piece and make the shell. Similar to the corner seams, the side wall weld seam can be welded from the inside and thereby have a weld bead inside the shell that affords for reduction and/or elimination of any grinding, cleanup, etc. that is typically required on the exterior of the shell. In other instances, the side wall can be made from two or more pieces of sheet metal and have two or more weld seams that can be welded from inside the shell. Welding of the corner and/or sidewall seams can be performed using any welding process or method known to those skilled in the art, illustratively including brazing with a low temperature brazing alloy, gas tungsten arc welding, gas metal arc welding and the like. In addition, a robotic system may or may not be used to perform the welding.

The side wall can have a lower portion or edge with a J-shaped section and at least a portion of the bottom panel located within the J-shaped section of the side wall in order to form an attachment joint between the side wall and the bottom panel. In addition, a tab of the J-shaped section can face or be located inwardly relative to the side wall and the bottom panel can have an inverted U-shaped section adjacent to the side wall with at least part of the U-shaped section being located within the J-shaped section in order to form the attachment joint. In some instances, a sealant can be located between a portion of the bottom panel and a portion of the side wall within the J-shaped section. In such instances, a casket having a securely attached bottom panel can be provided without welding of the bottom panel to the side wall. In addition, the casket shell can hold or contain a liquid without leaking.

In other instances, the bottom panel and at least one side wall can be integral with each other and be formed or stamped from a single piece of sheet metal. In such an instance, a generally planar piece of sheet metal has a plurality of side walls extending from the bottom panel, the sidewalls subsequently bent at a generally 90 degree angle relative to the bottom panel. In some instances, there can be four side walls—two side panels and two end panels—that extend from the bottom panel and which are bent at a generally 90 degree angle to the bottom panel. In addition, there can be at least four corners that have a welded seam, the welded seam made by welding of the corners from inside the shell.

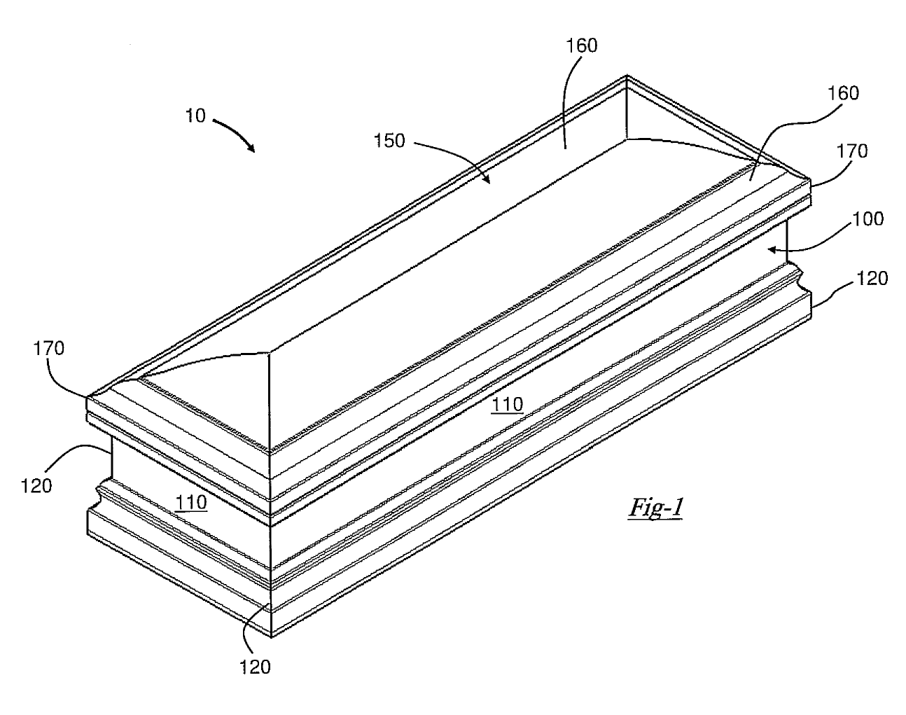

Turning now FIG. 1, a perspective view of a casket is shown generally at reference numeral 10. The casket 10 can have a base or shell 100 and a cover 150, the base 100 and cover 150 made from any suitable material known to those skilled in the art such as plain carbon steel, stainless steel, copper, copper alloys, nickel, nickel alloys, copper-plated material such as copper-plated steel, nickel-plated material such as nickel-plated steel, precious metal plated material, laminated material, plastics and the like. In addition, it is appreciated that the terms copper-plated material, copper-plated steel, nickel-plated material, nickel-plated steel include materials and/or steel plated with copper alloys or nickel alloys, respectively, and the term plated includes roller-bonded material, roller clad material, laminated material, explosive bonded material, weld overlay material and the like.

The shell 100 can have one or more side walls 110 with a corner 120 between adjacent side walls 110. It is appreciated from FIG. 1 that the side walls 110 can have a contoured shape that is provided by stamping, roll forming, and the like.

The cover 150 can likewise have a plurality of corners 170 and be made from one or more cover sections 160 that may or may not have a contoured shape. As illustrated in FIG. 1, the corners 120 are sharp bent corners, i.e. the sharp bent corners 120 have a radius of less than 0.5 inches and afford a generally 90 degree angle between two adjacent side panels 110.

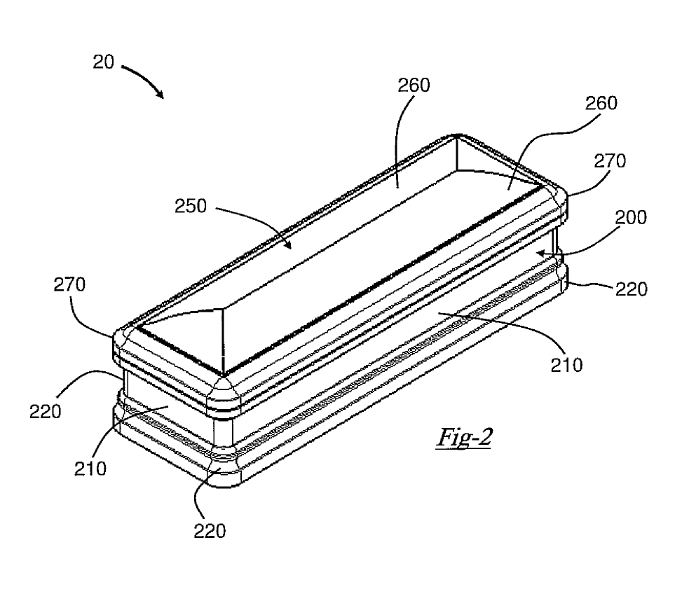

In contrast to the casket 10, a casket 20 is shown in FIG. 2, the casket 20 having round bent corners 220 with a radius of curvature greater than 0.5 inches. In addition, the casket 20 can have one or more side walls 210 that have a contoured shape and a cover 250 that likewise has rounded corners 270.

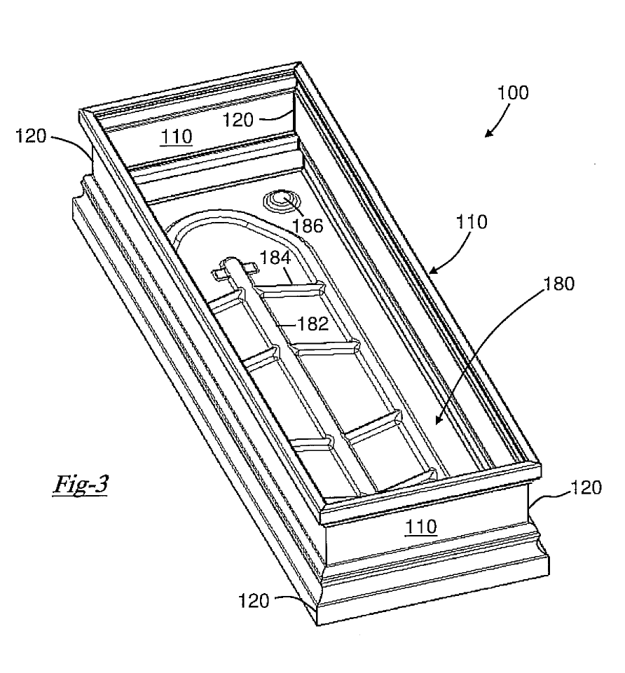

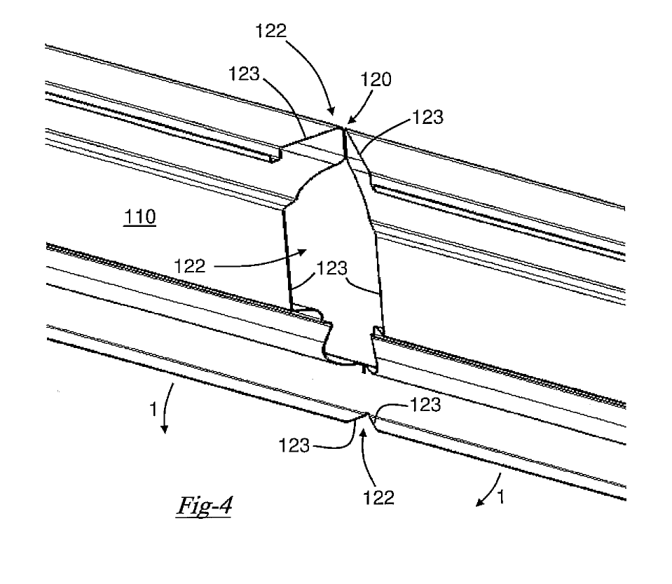

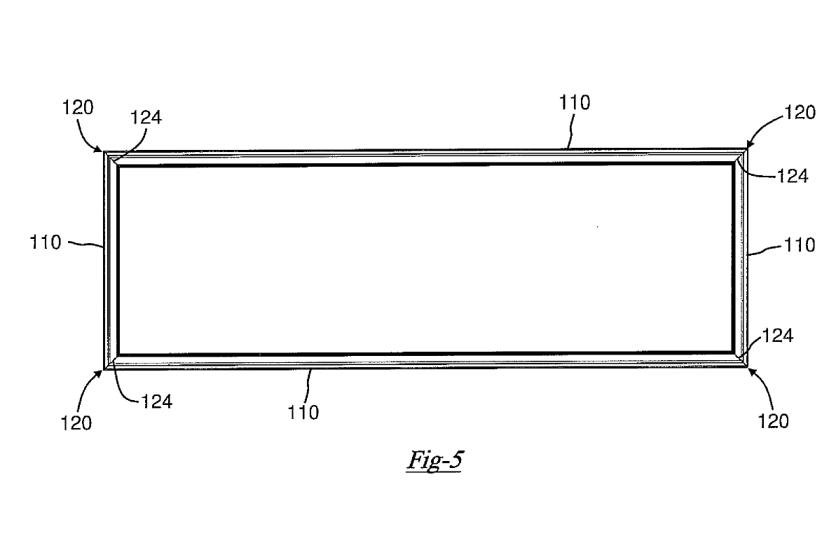

Turning now to FIG. 3, the base or shell 100 is shown without the cover 150, thereby providing a view of a bottom panel 180 having contours 182, 184, 186 and the like. It is appreciated that the contours within the bottom panel 180 can provide an increase in strength of the panel and/or provide an aesthetically pleasing design. As stated above, the corners 120 are sharp bent corners having a generally small radius of curvature and/or a seam that requires sealing. In some instances, such a corner can be made from a piece of sheet metal 102 having a contour and a cut-out section 122 that allows for the sheet metal 102 to be bent into a generally 90 degree shaped corner 120 as illustrated by arrows 1 and the four corners 120 in FIGS. 4 and 5. It is appreciated that the bending of the side wall 110 into a 90 degree angle results in a seam 124 between bounding cut-out section edges 123 being present along at least a portion of the corner 120.

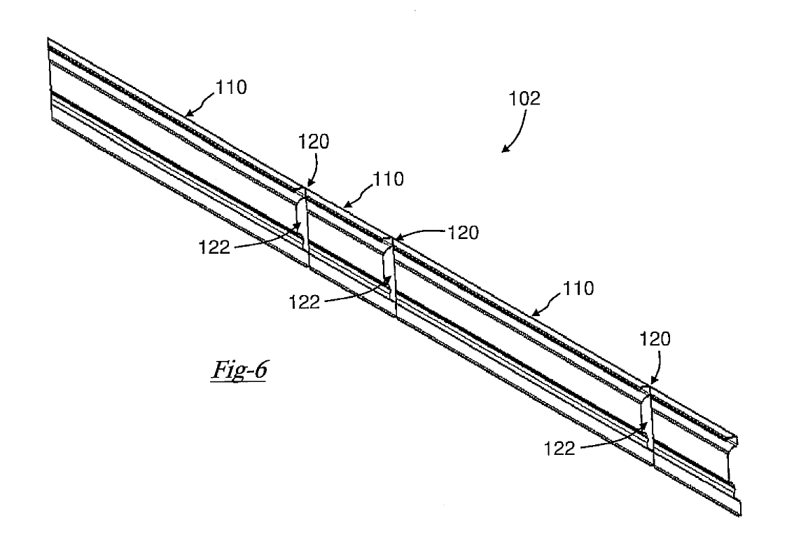

Referring now to FIG. 6, the piece of sheet metal 102 can be used to make two or more of the side walls 110 by having a plurality of cut-out sections 122 removed therefrom and thereby allowing for bending of the sheet metal 102 to form the plurality of corners 120. In this manner, a significant reduction in work required to make the base 100 can be achieved since separate pieces of sheet metal do not have to be aligned and then welded, bolted, etc. together in order to form the shell 100.

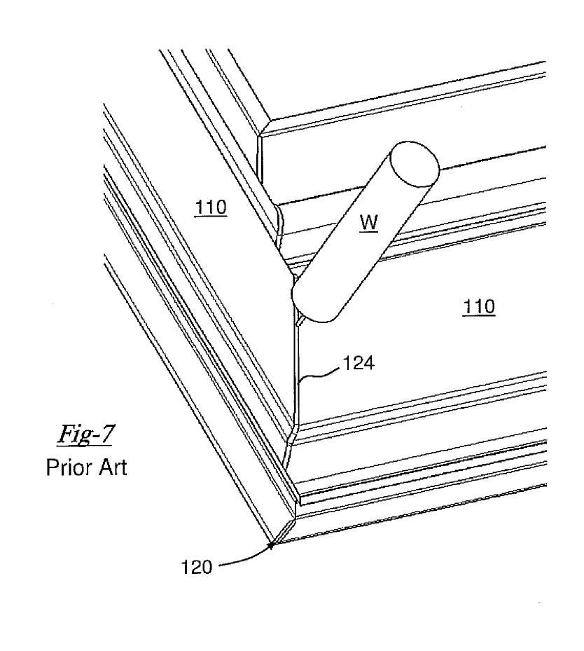

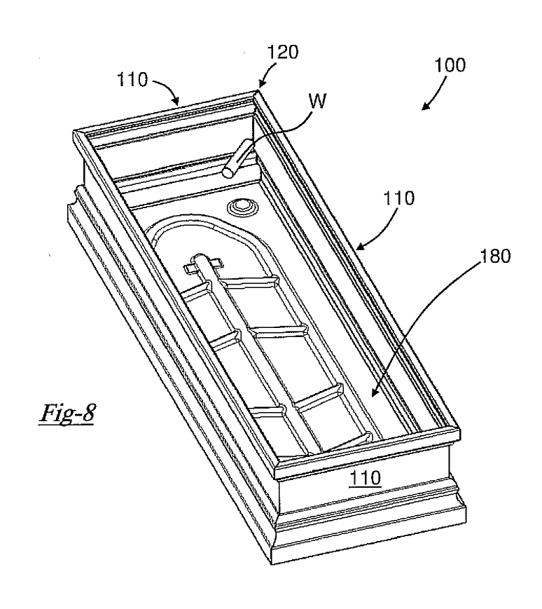

Referring now to FIGS. 7 and 8, FIG. 7 illustrates a prior art process in which a welding torch W is used to weld the seam 124 that is present along a portion of the sharp bent corner 120 from outside the shell 100. It is appreciated that welding of the seam 124 from outside the shell 100 results in weld metal and thus a weld bead being present on an outer surface of the seam 124 and shell 100. As such, excess weld metal, a rough weld bead, etc., must be sanded and/or ground down in order to provide a smooth surface in this area. It is appreciated that grinding, sanding, etc., results in additional labor required for the manufacture of the casket.

In the alternative, FIG. 8 illustrates an inventive process where the welding torch W is used to weld the seam 124 from within or on an interior side of the shell 100. Such a process affords for weld metal and/or a weld bead to be located on the interior side of the shell 100 where it is not visible to the eye, and thus can minimize and/or eliminate sanding, grinding, etc., of the exterior side of the corners 120 due to welding. In addition to the corners 120, the welding torch W can be used to weld the bottom panel 180 to the side wall 110 from inside the shell 100 and therefore further reduce the amount of weld metal, weld bead, etc. that must be sanded, ground, etc., on the exterior of the casket.

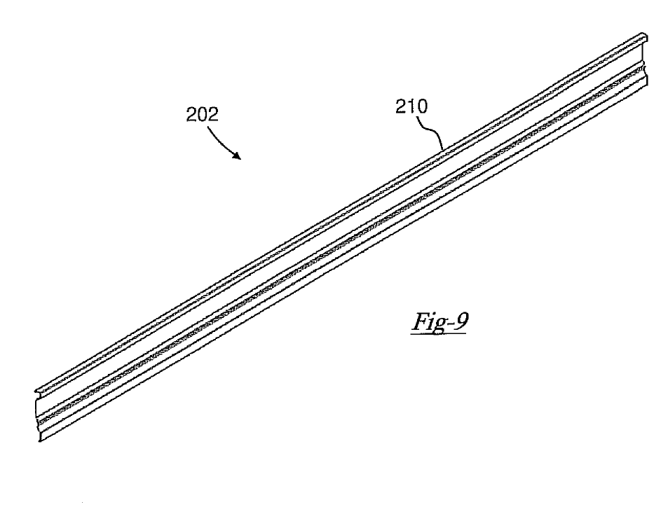

Referring back to casket 20 shown in FIG. 2, and to FIGS. 9-10, a side wall 210 having a contoured shape can be stretch bent in order to form a plurality of round bent corners 220 as illustrated in FIG. 10. It is appreciated that the round bent corners 220 have a generally large radius of curvature (e.g. greater than 1 inch) and the corners can be seamless. In some instances, a first half of the shell side walls can be fabricated by stretch bending two of the corners 220 out of a single piece of sheet metal 202, and then a second half of the shell side walls can be fabricated by stretch bending two more of the corners 220 out of a separate piece of sheet metal. Thereafter, the two halves can be joined together, for example by welding of the two seams that are present when the two halves are fit together to make the shell 200. It is appreciated that the seams can be welded from inside the shell 200 as discussed above for the corners of shell 100.

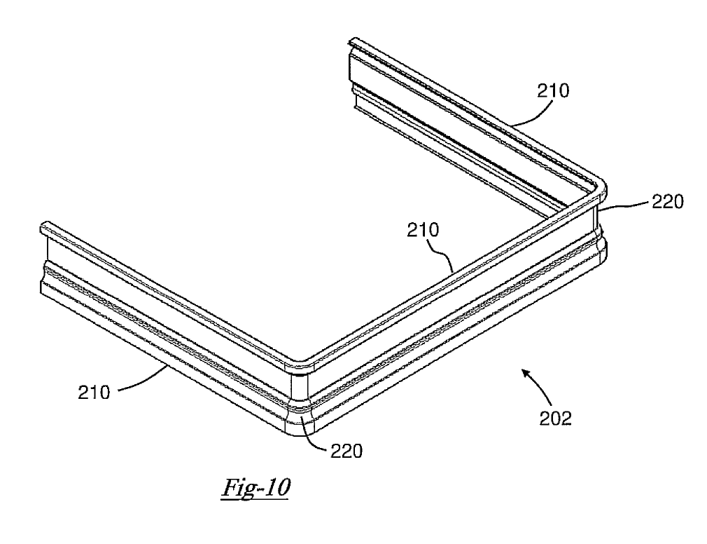

In the alternative, all four of the round bent corners 220 can be stretch bent from a single piece of sheet metal with only a single welded seam 215 required as illustrated in FIG. 11. It is appreciated that the seam 215 shown in FIG. 11, or two or more seams as would be present in FIG. 10, can be joined by welding the seams from inside and/or outside of the shell 200.

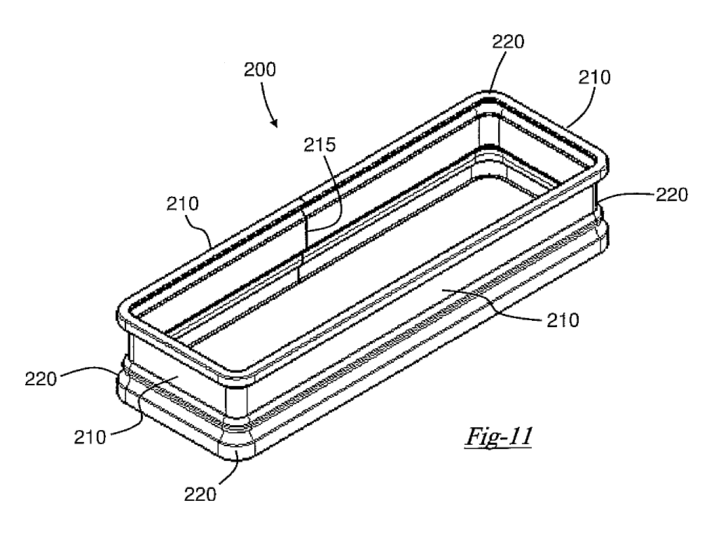

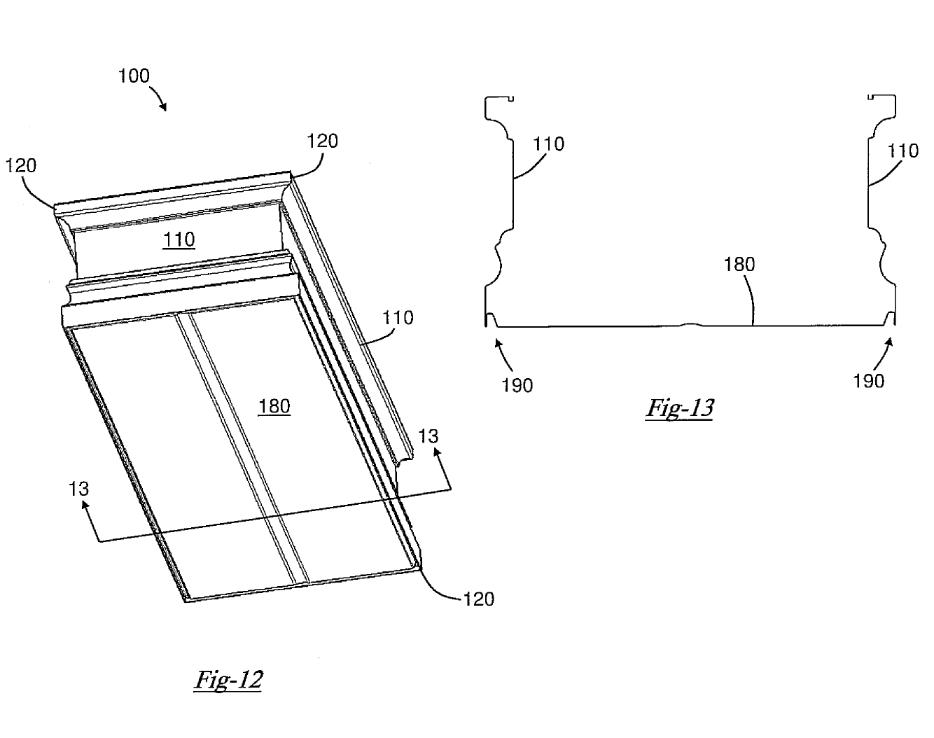

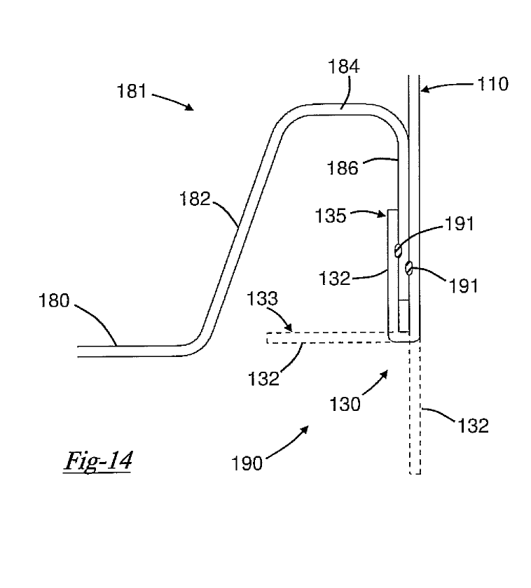

Turning now to FIGS. 12 and 13, a bottom perspective view of the casket shell 100 and end cross-sectional view of the section labeled 13-13 in FIG. 12 are shown. The shell 100 can have a bottom panel 180, side wall 110 and an attachment joint 190 between the side wall 110 and bottom panel 180. FIG. 14 illustrates an enlarged view of the attachment joint 190 with the side wall 110 having a J-shaped portion or section 130 made and at least a portion of the bottom panel 180 located within the J-shaped section 130. In some instances, the bottom panel 180 can have an inverted U-shaped portion or section 181 as shown in the figure with a portion of the U-shaped section 181 being located within the J-shaped section 130 of the side wall 110. In such an instance, the U-shaped section 181 of the bottom panel 180 can have a first leg 182 with a second leg 184 extending therefrom and a third leg 186 extending from the second leg 184. In addition, a portion of the third leg 186 can be located between the side wall 110 and a leg portion or tab 132 of the side wall.

As shown in the figure, the tab 132 can be rolled to a first position 133 and then to a second and final position 135. Such an operation can be performed using roll hemming as known to those skilled in the art in order to provide an interlocking structure between the bottom panel 180 and the side wall 110. A sealant 191 can be optionally provided between the third leg 186 and the side wall 110 and/or between the third leg 186 and the tab 132 in the final position 135. In this manner, attachment of the bottom panel to the side wall 110 to provide a structurally secure shell 100 can be provided without welding of the bottom panel 180 to the side wall 110, It is appreciated that the J-shaped section and inverted U-shaped section can likewise be used between the bottom panel 180 and a sidewall 210 in order to provide a structurally secure shell 200.

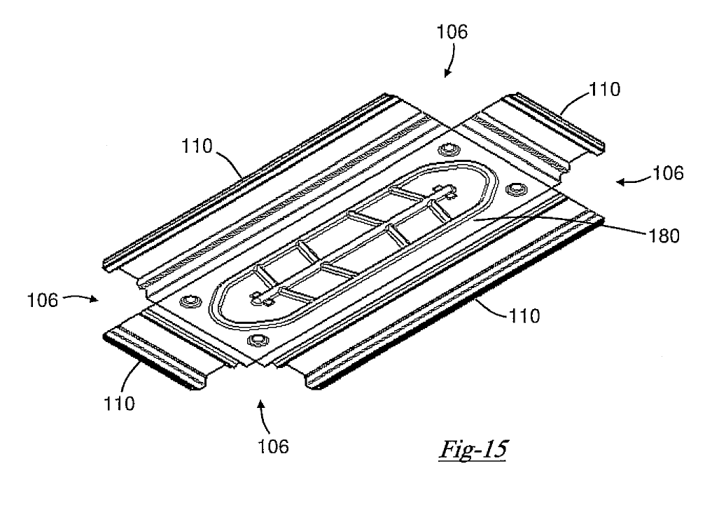

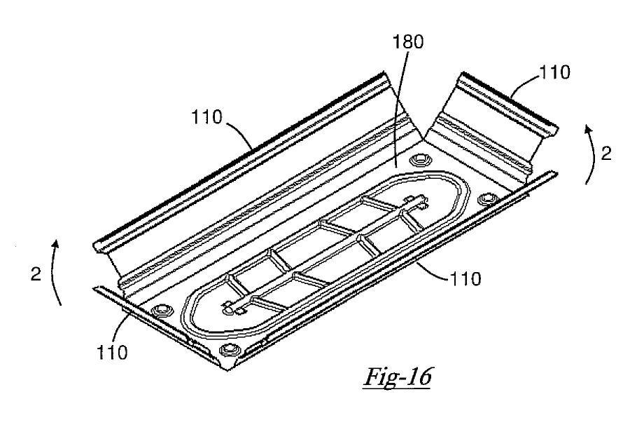

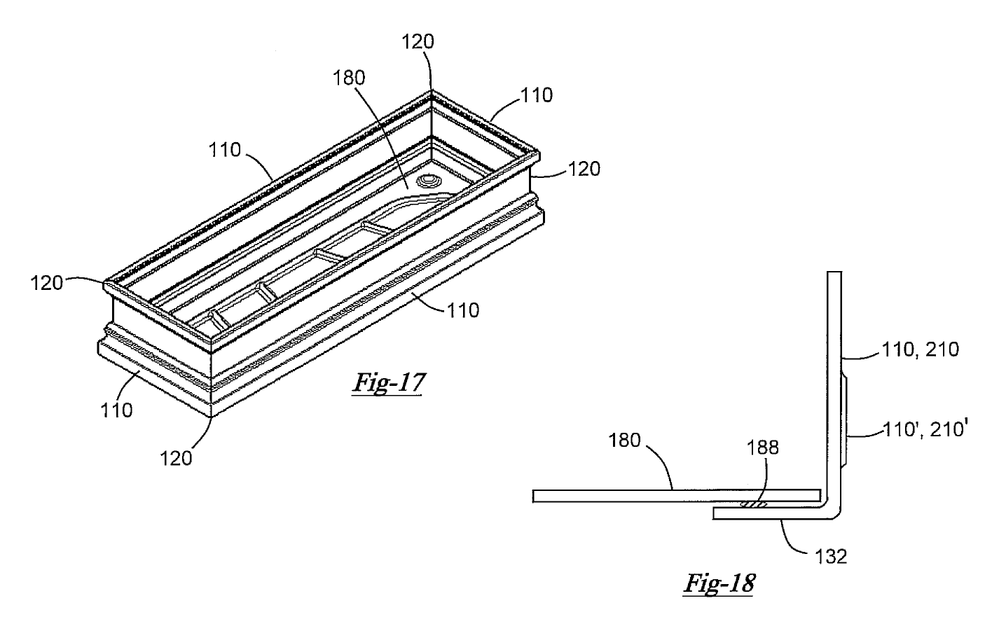

Referring now to FIG. 15, a single piece of sheet metal that has been stamped to form the bottom panel 180 and a plurality of side walls 110 is shown. It is appreciated that such a piece of sheet metal can have sections 106 removed before or after any contour shape in side walls 110 or the bottom panel 180 is provided, the sections 106 removed using water-jet cutting, abrasive water-jet cutting, EDM, shearing and the like. In addition, the plurality of side walls 110 can be bent in a direction generally shown by arrows 2 in FIGS. 16 and 17 such that the side walls 110 can have a generally 90 degree orientation relative to the bottom panel 180. In addition, the corners 120 shown in FIG. 17 can be welded from inside the shell 100 as described above in order to reduce and/or eliminate any sanding, grinding, etc., of the corners 120 that has heretofore been required during the manufacture of caskets. It is appreciated that a seam between the bottom panel 180 and the plurality of side walls 110 is not present and thus the joining of the bottom panel to the plurality of side walls 110 is not required.

In another embodiment, the bottom panel 180 can be joined to the plurality of sidewalls 110 or 210 using a sealant 188 as illustrated in FIG. 18. The sidewalls 110 or 210 can have an external layer 110′ or 210′ in the form of copper, copper alloys, nickel, nickel alloys and the like, thereby providing a plated material as discussed above. In addition, the cover 150 or 250 can also have an external layer similar to 110′ or 210′ such that, for example, a copper-plated or nickel-plated casket is provided.

In some instances, the tab 132 and/or an edge portion of the bottom panel 180 can have a one part epoxy placed thereon and the panel 180 placed in contact with and/or proximate to side walls 110 or 210 with the epoxy therebetween and as illustrated in FIG. 18. Any sealant known to those skilled in the art can be used, illustratively including Terokal® 4555B™ manufactured by the Henkel Corporation having a corporate office at One Henkel Way, Rocky Hill, Conn. In some instances, the sealant can be cured using heat, for example during a paint curing process. In still other instances, the bottom panel 180 and the tab 132 can be tacked together and thus held together such that the panel 180 and leg portion 132 remain in proximity to each other until a sealant curing process can be performed.

In addition to having sealant between the bottom panel 180 and a portion of the side walls 110 or 210, sealant can be present and/or applied to all seams, corners, etc. of the casket 10 or 20 in order to provide at least a temporary liquid tight container. It is appreciated that the sealant can be applied on the inside and/or outside of the casket using a robotic system and/or an individual.

The cover 150 and/or the cover 250 can be fabricated using similar processes, methods, materials and the like as shown for the shell 100 and the shell 200. In the alternative, the cover 150 and/or 250 can be made from a single piece of sheet metal that is stamped, deep drawn, and the like. In addition to the fabrication techniques described above, it is appreciated that additional painting, sandblasting, grinding, etc. can be included in order to produce a desirable casket.

The invention is not restricted to the illustrative examples and/or embodiments described above. The examples and/or embodiments are not intended as limitations on the scope of the invention. Methods, apparatus, compositions, and the like described herein are exemplary and not intended as limitations on the scope of the invention. Changes therein and other uses will occur to those skilled in the art and, as such, the specification should be interpreted broadly,

I claim:

1. A casket comprising:
a shell and a cover;
said shell having a bottom panel and a side wall, said side wall having a plurality of bent corners with at least a portion of each bent corner being seamless.

2. The casket of claim 1, wherein said plurality of bent corners each has a cut-out section.

3. The casket of claim 1, wherein each of said plurality of bent corners is completely seamless.

4. The casket of claim 3, wherein each of said plurality of bent corners is roller bent without a seam.

5. The casket of claim 4, wherein said side wall is a single piece of sheet metal with only one joining seam.

6. The casket of claim 5, wherein said one joining seam is a welded seam welded from inside with a weld bead inside said shell.

7. The casket of claim 4, wherein said side wall is two pieces of sheet metal with only two joining seams.

8. The casket of claim 7, wherein said two joining seams are welded seams welded from inside with weld beads inside said shell.

9. The casket of claim 1, wherein a lower portion of said side wall has a J-shaped portion with at least a portion of said bottom panel located within said J-shaped section of said side wall.

10. The casket of claim 9, wherein said bottom panel has an inverted U-shaped section adjacent said side wall with at least part of said U-shaped section located within said J-shaped section of said side wall.

11. The casket of claim 9, farther comprising a sealant located between a portion of said bottom panel and a portion of said side wall within said J-shaped section.

12. The casket of claim 1, wherein said shell and said cover are a copper-plated steel shell and a copper-plated steel cover.

13. A casket comprising:
a shell and a cover;
said shell having a bottom panel and a plurality of side walls, said bottom panel and said plurality of side walls being integral and stamped from a single piece of sheet metal.

14. The casket of claim 13, wherein said plurality of side walls are bent at a generally 90 degree angle to said bottom panel forming a plurality of corners between said plurality of side walls.

15. The casket of claim 14, wherein said plurality of corners each has a welded seam, said welded seam welded from inside and having a weld bead inside said shell.

16. The casket of claim 13, wherein said shell and said cover are a copper-plated steel shell and a copper-plated steel cover.

17. A process for making a casket, the process comprising:
forming a bottom panel from a first piece of sheet metal;
forming a cover from a second piece of sheet metal;
stretch roller bending a third piece of sheet metal to form a panel with a plurality of seamless corners;
joining at least two opposed edges of the panel to form a generally rectangular casket sidewall;
attaching the bottom panel to the casket sidewall; and
attaching the cover to the casket sidewall.

18. The process of claim 17, wherein the joining of the at least two opposed edges of the panel is performed by welding the edges from inside of the casket sidewall.

19. The process of claim 18, farther including hemming a bottom edge of the casket sidewall to form a tab extending in an inwardly direction, the bottom panel extending over the tab when attached to the casket sidewall.

20. A process for making a casket, the process comprising:
forming a bottom panel from a first piece of sheet metal;
forming a cover from a second piece of sheet metal;
removing a plurality of sections from a third piece of sheet metal to form a panel with a plurality of cut-out sections;
bending the panel to produce a plurality of bent corners with each bent corner having one of said cut-out sections and a seam;
joining at least two opposed edges of the panel to form a generally rectangular casket sidewall;
attaching the bottom panel to the casket sidewall; and
attaching the cover to the casket sidewall.

21. The process of claim 20, further including welding the seam of each bent corner from inside the casket sidewall.

22. The process of claim 20, further including applying a sealant between the bottom panel and the casket sidewall.
